(19) United States
(12) Patent Application Publication
(10) Pub. No.: US 2026/0121739 A1
(43) Pub. Date: Apr. 30, 2026

(54) METHOD OF ENABLING MOBILE DEVICE COMMUNICATION VIA AN ACCESS NETWORK, METHOD OF MANAGING A SUBSCRIBER DATABASE IN A HOME OPERATOR NETWORK, METHOD OF COMMUNICATING BETWEEN A SATELLITE ACCESS NETWORK AND HOME OPERATOR NETWORK, NETWORK ENTITY AND COMPUTER SOFTWARE

(71) Applicant: Vodafone Group Services Limited, Newbury, Berkshire (GB)

(72) Inventors: Marco BROSZEIT, London (GB); Chris PUDNEY, London (GB); Yang LU, London (GB)

(21) Appl. No.: 19/475,796

(22) PCT Filed: Apr. 8, 2024
(86) PCT No.: PCT/GB2024/050932

§ 371 Date: Oct. 16, 2025

(30) Foreign Application Priority Data
Apr. 17, 2023 (GB) 2305624.5
Jul. 25, 2023 (GB) 2311413.5

(51) Int. Cl. H04B 7/185

(52) U.S. Cl. CPC H04B 7/18565; H04B 7/18539; H04B 7/18545

(57) ABSTRACT

A method of enabling mobile device communication via an access network is provided. The access network is a satellite access network that does not have permanent connectivity with a subscriber authentication center in the HPLMN. The method comprises receiving, at a satellite access node of the satellite access network, a request from a mobile device to use the satellite access network. The request comprises an identifier of a mobile subscriber associated with the mobile device. The method further comprises sending a message to a subscriber database in a home operator network of the mobile subscriber. The message comprises the identifier and one or more of:
a) a timestamp indicating when the mobile device requested to use the satellite access network; and
b) information to enable the home operator network to determine that the access network is a satellite access network.

### FIELD

The present invention relates to telecommunications methods using a satellite-based access network. Specifically, the invention provides improved methods where the connectivity between the satellite-based access network and terrestrial network elements is incomplete, intermittent and/or partial.

### GLOSSARY

3GPP—3rd Generation Partnership Project
GSM—Global System for Mobile Communications
GSMA—GSM Association
LTE—Long Term Evolution (4G)
LTE-A—LTE-Advanced
HSS—Home Subscriber Server
LEO—Low Earth Orbit
eNB—Evolved Node B
MME—Mobility Management Entity
PDN—Packet Data Network
PDN GW—PDN Gateway
UE—User Equipment
IMSI—International Mobile Subscriber Identifier
TMSI—Temporary Mobile Subscriber Identity
NAS—Non-Access-Stratum
EPS—Evolved Packet System
EPC—Evolved Packet Core
PLMN—Public Land Mobile Network
HPLMN—Home PLMN
VPLMN—Visited PLMN
GPRS—General Packet Radio Service
SGSN—Serving GPRS Support Node
MSC—Mobile Switching Centre
CN—Core Network
SIM—Subscriber Identity Module
TAI—Tracking Area Identity
MCC—Mobile Country Code
MNC—Mobile Network Code
RAT—Radio Access Technology
RAN—Radio Access Network
RMF—Roaming Management Function
ISD—Insert Subscriber Data
ATI—Any Time Interrogation
PSI—Provide Subscriber Information
EPC—Enhanced Packet Core
ULR—Update Location Request
CLR—Cancel Location Request
BTS—Base Transceiver Station
BSS—Basic Service Set
BS—Base Station
ESS—Extended Service Set
AP—Access Point
gNB—g Node B
TRP—Transmission and Reception Point
CDMA—Code Division Multiple Access
FDMA—Frequency Division Multiple Access
TDMA—Time Division Multiple Access
OFDMA—Orthogonal Frequency Division Multiple Access
SC-FDMA—Single Carrier Frequency Division Multiple Access
MC-FDMA—Multicarrier Frequency Division Multiple Access
UTRA—Universal Terrestrial Radio Access
E-UTRA—Evolved UTRA
UMTS—Universal Mobile Telecommunications System
E-UMTS—Evolved UMTS
EDGE—Enhanced Data Rates for GSM Evolution
IEEE—Institute of Electrical and Electronics Engineers
DL—Downlink
UL—Uplink
NR—New Radio
TE—Terminal Equipment
MS—Mobile Station
MT—Mobile Terminal
UT—User Terminal
SS—Subscriber Station
PDA—Personal Digital Assistant
ABS—Advanced Base Station
PS—Processing Server
CSI—Channel State Information
CSI-RS—Channel State Information Reference Signal
CRS—Cell-specific Reference Signal
FPGA—Field-Programmable-Gate-Array
ASIC—Application-Specific-Integrated-Circuit
DSP—Digital-Signal-Processor
ROM—Read-Only Memory
RAM—Random-Access Memory
EEPROM—Electrically Erasable Programmable Read-Only Memory
EPROM—Erasable Programmable Read-Only Memory
CD-ROM—Compact Disc Read-Only Memory
DVD-ROM—Digital Versatile Disc Read-Only Memory

### BACKGROUND

Telecommunications coverage can be provided to mobile devices using access networks that are hosted on one or more satellites. This is useful for providing coverage (e.g., a data connection) where terrestrial access networks are not available. In one example, tracking devices may require a cellular data connection to report their location to a central server. If the tracking device is on a cargo ship in a remote part of an ocean, it is unlikely that any standard land-based networks will be able to support a data connection to the tracking device. However, telecommunications satellites in a low earth orbit (LEO) may be able to provide coverage in places around the world that terrestrial networks do not cover.

In order to provide complete global coverage at all times, many satellites are needed (around 250 in some cases, depending on the constellation pattern). However, building and launching satellites into space requires considerable resources. Therefore, it is desirable to provide mobile access to satellite services with fewer satellites that form a less dense or incomplete satellite constellation.

In order to provide coverage, the satellites also need to communicate with one or more Earth stations. To ensure that each satellite is always in communication with at least one Earth station, several hundred Earth stations are required at locations around the world. Earth stations also require considerable resources to deploy. Moreover, some locations may be difficult or impossible to situate Earth stations, due to geographic or political reasons. Therefore, reducing the number of Earth stations required is also advantageous. However, having a small number of Earth stations has the result that each satellite is not in range of an Earth station at all times.

There exist solutions that address these issues by providing a messaging capability for a satellite constellation with incomplete global coverage, and with limited connectivity between the satellite and the Earth station. In cases where latency is not an issue, data may be sent from the mobile device to the satellite when the mobile device is in range of the satellite, stored by the satellite, and forwarded to an Earth station when the Earth station is in range of the satellite. For example, 3GPP documents from Mediatek et al. in 3GPP C1-230376 and C1-230377 describe installing a 3GPP LTE base station and (most of) a core network on the satellite to create a “store-and-forward”messaging capability. These documents propose feature additions to the NAS protocol for EPS defined in 3GPP Specification 24.301, which is incorporated by reference, along with C1-230376 and C1-230377.

One problem that arises from attempting to provide coverage when the satellite is not in range of an Earth station is that when the mobile (UE) first contacts (attempts to ‘Attach’ to) the satellite, the satellite cannot retrieve the authentication vectors from the HSS in the home network. One possible solution proposed by the prior art is illustrated in the following four steps:
a. A LEO satellite, which comprises an eNB, MME and Serving Gateway (and optionally PDN GW), orbits the Earth such that each point on the earth gets coverage once every 12 hours, for example. The satellite is in connection with an Earth station once every 6 hours, for example.
b. The mobile device detects coverage from the satellite, sends an Attach Request, and the MME in the satellite requests that the mobile device (UE) sends the IMSI to the MME. The Attach procedure then fails (either with an error or a timeout) because the MME is not in contact with the Earth station and hence cannot retrieve Authentication/Security vectors from the HSS.
c. The MME stores the IMSI and, when the satellite is subsequently in coverage of an Earth station (perhaps minutes or hours later), the MME requests authentication vectors (and optionally subscription data) for that IMSI from the HSS and stores the data in the MME in the satellite.
d. When the UE next comes into the coverage of the satellite, the UE attempts to Attach again. This time, the MME has the security vectors and can authenticate the UE, and the Attach Request succeeds. A PDN connection between the mobile device and the satellite can be established and data sent from UE to satellite.

An example message flow for a 4G EPC Attach process is illustrated in FIG. 1. This message flow is described in detail in 3GPP Specification 23.401, which is incorporated by reference. However, when applied to the satellite access network described above (with incomplete coverage and/or intermittent connectivity), this Attach process suffers from drawbacks and security vulnerabilities that make it unsuitable for providing a satellite-based VPLMN, as will be explained below.

### SUMMARY

A method of enabling mobile device communication via an access network (which may be referred to as a Visited Public Land Mobile Network, VPLMN). The access network is a satellite access network. The method comprises:
receiving, at a satellite access node of the satellite access network, a request (e.g., an Attach Request, as defined in 3GPP Specifications for 4G EPS, such as 23.401) from a mobile device (such as a UE) to use the satellite access network, wherein the request comprises an identifier of a mobile subscriber associated with the mobile device;
sending (e.g., by the MME of the satellite access network) a message to a subscriber database in a home operator network of the mobile subscriber, wherein the message comprises the identifier (e.g., IMSI) and one or more of:
   a) a timestamp (such as absolute time or a time elapsed) indicating when the mobile device requested to use the satellite access network; and
   b) information to enable the home operator network to determine that the access network is a satellite access network.

The identifier of the mobile subscriber associated with the mobile device may be an IMSI, which uniquely identifies the mobile subscriber, or a temporary identifier that triggers the satellite access network to request the mobile communication devices to send its IMSI to the satellite access network.

The identifier may be a permanent identifier.

In one example, a TMSI may be sent in the message in step 1 illustrated in FIG. 1. The IMSI may be sent in the message in step 4 illustrated in FIG. 1 (Identity Response). The IMSI (rather than TMSI) is sent from the MME to the HSS.

The authentication process may be a precursor to storing communications and subsequently forwarding the communications to the home operator network (HPLMN) and/or intended recipient of the communication. However, the communications need not be routed via the HPLMN. The system may be described as a “store-and-forward” system.

The timestamp may indicate when the request is received by the satellite access node, when the request is sent by the mobile device, or when the mobility manager determines that the satellite node is not connected to an Earth station, for example.

The information enabling the home operator network (e.g., the subscriber database of the home operator network) to determine that the access network is a satellite access network may be an indication (or flag) in the message that the access network is a satellite access network. The indication or flag may indicate that the satellite access network is a store-and-forward type access network. The indication or flag may indicate that the satellite access network is a store-and-forward type access network with incomplete, intermittent and/or non-permanent connectivity to Earth stations.

The HPLMN may use the VPLMN's Mobile Country Code (MCC) and a Mobile Network Code (MNC) to identify the PLMN and determine the type of the PLMN (access network).

In some prior art methods, these parameters are included in the Update Location Request (step 8 in FIG. 1) but not in the Authentication Request (step 5a in FIG. 1). The proposed methods may include these parameters, and/or the timestamp, in the Authentication Request (step 5a from MME to HSS, in FIG. 1), as well as the Update Location Request (step 8 in FIG. 1). In the proposed methods, these parameters may be set to indicate that the access network is a satellite access network (such that the home operator network can determine that the access network is a satellite access network and act accordingly).

As an alternative to providing this information in the Mobile Country Code and Mobile Network Code parameters, a new Radio Access Technology (RAT) type may be defined to indicate to the home operator network that the access network is a satellite access network. Some existing RAT types indicate that a network is a satellite network. However, no existing RAT types differentiate between satellite networks having the UE currently connected to the satellite, and e.g., store-and-forward type networks where the UE might no longer be connected to the satellite. In one example, the proposed methods therefore require a definition of a new RAT type that is indicated in a message (e.g., the Authentication Request and/or the Update Location Request) and understood by the home operator network, where the RAT type relates to (e.g. satellite) access networks that request authentication parameters (e.g. security vectors) without the UE being in current contact with that access network(e.g., store-and-forward type networks).

A request to use the satellite access network may be a request to communicate via the satellite access network (in other words, “access via the satellite access network”). Since the satellite access network may be a store-and-forward network, the request may be a request to send data via the satellite access network (e.g., with no expectation of receiving a reply, due to the high latency).

Once authentication has completed, the mobile device is able to connect to the Visited PLMN using security credentials from the HPLMN. The mobile device is therefore able to send data via the VPLMN.

A request to “use” the satellite access network may be considered a request to connect via the satellite access network. For example, the mobile device may request to connect via the satellite access network to a home operator network (HPLMN) of the mobile subscriber.

In another example, the mobile device may request to connect via the satellite access network to a server accessible via the internet, using security credentials from the HPLMN.

The method may further comprise storing a record of the request from the mobile device, wherein the record comprises the identifier and the timestamp.

The method may further comprise storing a record of the request from the mobile device, wherein the record comprises the identifier.

The record may be stored in the satellite access network.

Storing a record of the request from the mobile device may comprise storing the record at a mobility manager of the satellite access network (e.g., a Mobility Management Entity MME in one example, or 5G Core Access and Mobility Management Function AMF in another example).

The message sent to the subscriber database may comprise a request to update a location register of the subscriber database (e.g., step 8 in FIG. 1).

The location register may comprise an entry in respect of a plurality of subscribers and the request may be to update the entry in respect of the mobile subscriber corresponding to the identifier.

The request may further comprise a request to cancel a connection in respect of an access network previously identified in the location register.

The method may further comprise sending, to the subscriber database, a request for authentication data (e.g., step 5a in FIG. 1).

Alternatively, the message sent to the subscriber database may comprise a request for authentication data (e.g., step 5a in FIG. 1).

In this case, the method may further comprise sending, to the subscriber database, a request to update a location register of the subscriber database.

The timestamp in a) and/or the information in b) may be sent to the subscriber database in the request for authentication data, the request to update the location register, or both.

Following successful authentication using the authentication data, the mobility manager of the satellite access network may complete the Attach process by requesting that the subscriber database updates the mobile subscriber location entry in the location register of the subscriber database.

In some examples, the satellite access network does not have permanent connectivity with a subscriber authentication centre in the HPLMN.

The method may further comprise determining that a connection between the satellite access node and the home operator network is not available.

The method may further comprise determining (e.g., at a later time) that a connection between the satellite access node and the home operator network is available (e.g., via an Earth station of the satellite access network, which comes into range of the satellite access node). The request for authentication data may be sent to the subscriber database in response to the determination that the connection between the satellite access node and the home operator network is (or was) available.

The connection between the satellite access node and the Earth station may be a wireless data connection. Each Earth station is permanently connected to the home operator network (e.g., via a wired data connection). Therefore, determining that a connection between the satellite access node and the home operator network is not available is analogous to determining that a connection between the satellite access node and an Earth station is not available.

Determining that a connection between the satellite access node and the home operator network is not available may comprise requesting the authentication data and determining that a time-limit for receiving a response to the request has been exceeded.

Alternatively, determining that a connection between the satellite access node and the home operator network is not available may comprise determining that an Earth station of the satellite access network is no longer in range of the satellite access node.

Sending the message to the subscriber database may comprise sending the message (comprising the identifier) to the subscriber database via a roaming hub. Preferably, where the message is sent via a roaming hub, the message further comprises the timestamp (in accordance with option a) of the options presented).

A method of managing a subscriber database (e.g., an HSS) in a home operator network is also provided. The method comprises receiving, at the subscriber database, a message from an access network (e.g., from an MME in a VPLMN). The access network is a satellite access network. The message comprises an identifier of a mobile subscriber that has requested to use the satellite access network. The message further comprises one or more of:
a) a timestamp indicating when the mobile subscriber requested to use the satellite access network (e.g., when the request was received by the satellite access node, when the request was sent by the UE or when the MME determined that a connection to an Earth station was not available); and
b) information enabling the home operator network to determine that the access network is a satellite access network.

The message may comprise a request for authentication data (e.g., security vectors).

The message may correspond to the Authentication Request described in step 5a in relation to FIG. 1.

The method may further comprise receiving a request to update a location register of the subscriber database (e.g., step 8 described in relation to FIG. 1).

The request to update a location register may be a request to update a location register entry in respect of the mobile subscriber corresponding to the identifier.

The request may further comprise a request to cancel the previous location Attach (or may induce the subscriber database to do so).

The message may comprise a request to update a location register of the subscriber database.

The message may correspond to the Update Location Request described in step 8 in relation to FIG. 1.

The method may further comprise receiving a request for authentication data (e.g., security vectors).

The method may further comprise determining whether the mobile subscriber has accessed via a different access network (e.g., a terrestrial access network) more recently than the request to use the satellite access network.

During the delay between the mobile subscriber requesting to use the satellite access network and the satellite access node sending a message to the subscriber database, the mobile subscriber may access via a different access network (e.g., a terrestrial PLMN with full connectivity on the path between UE, MME and HSS). In this case, the request to use the satellite access network is out of date and therefore should not be actioned by the subscriber database when it does arrive (and, more specifically, should not lead to the cancellation of the registration in the more recently used PLMN).

If the mobile subscriber has accessed via a different access network more recently than the request to use the satellite access network, the method may further comprise either:
responding to the message from the satellite access network with an error; or
disregarding the message from the satellite access network (causing a timeout).

If the mobile subscriber has not accessed via a different access network more recently than the request to use the satellite access network, the method may further comprise responding to the message by one or more of:
sending authentication data to the satellite access network; and
updating a location register of the subscriber database.

Updating a location register of the subscriber database may comprise updating a specific entry in the subscriber database relating to the mobile subscriber. The entry may be updated by storing an identity of the mobility manager of the satellite access network.

In addition to updating the location register of the subscriber database, the subscriber database may also send a cancel message to a previous access network.

Determining whether the mobile subscriber has accessed via a different access network more recently than the request to use the satellite access network may comprise sending a message to a mobility manager of an access network currently identified in a location register of the subscriber database (in respect of the mobile subscriber), to determine when the mobile subscriber last accessed via an access network currently identified in the location register of the subscriber database.

If the mobile subscriber accesses via a new or different access network, the subscriber database would be notified. If the mobile subscriber attempts to access via the satellite access network but then reverts to the previous access network during the delay, this may not generate a record at the subscriber database. Therefore, the subscriber database should check with the previous access network to determine whether the mobile subscriber has accessed via the previous access network since the request to use the satellite access network.

Access via a different access network (which can include the HPLMN) could be mobile originated and need not involve the subscriber database in the HPLMN. Therefore, there may not be an explicit request to connect that reaches the subscriber database. Querying the previous access network provides a reliable time that the mobile subscriber last accessed via that network.

The message sent to the mobility manager of the currently identified access network may be an Insert Subscriber Data (ISD) message. The subscriber database (in the HPLMN) may contact the circuit and/or packet domain (e.g., the circuit domain MSC and/or the packet domain MME/AMF) in the previous access network (VPLMN or HPLMN).

In some alternative examples, the message sent to the mobility manager of the currently identified access network may be an Any Time Interrogation (ATI) message.

The subscriber database may be configured to maintain:
a first location register entry in respect of registrations made from the mobile subscriber via (satellite) access networks without an active connection to the mobile, and
a second location register entry in respect of connections made from the mobile subscriber via other access networks.

The method may further comprise updating the first location register entry (e.g., with an identifier of the mobility manager of the satellite access network).

A location register may contain an entry corresponding to the mobile subscriber. The entry may comprise an identifier of a mobility manager (e.g., MME) in the access network via which the mobile subscriber last connected. In the case that two location registers are maintained per subscriber, the first may relate to satellite access networks and the second may relate to other access networks.

In one example, the first location register entry may relate to satellite access networks and the second location register entry may relate to terrestrial access networks.

The first location register entry may relate specifically to store-and-forward type satellite access networks.

In this case, the second location register entry may relate to terrestrial networks and satellite access networks that are not of the store-and-forward type.

A method of communicating between a satellite access network and a home operator network is provided. The method comprises receiving, at a roaming hub, a message from a satellite access network (e.g., from a mobility manager of the satellite access network). The message comprises:
an identifier of a subscriber device that has requested to use the satellite access network, and
a timestamp indicating when the mobile subscriber requested to use the satellite access network.

The method steps may be performed by a roaming management function (RMF) of the roaming hub.

The method may further comprise determining whether the mobile subscriber has accessed via a different access network more recently than the request to use the satellite access network.

If the mobile device has accessed via a different access network more recently than the request to use the satellite access network, the method may further comprise either:
responding to the message from the satellite access network with an error, or
disregarding the message from the satellite access network (causing a timeout).

If the mobile subscriber has not accessed via a different access network more recently than the request to use the satellite access network, the method may further comprise forwarding the message to a subscriber database of the home operator network.

Determining whether the mobile subscriber has accessed via a different access network more recently than the request to use the satellite access network comprises:
maintaining, by a roaming management function (RMF) of the roaming hub, a record of previous registrations relating to the mobile subscriber, and
sending a message to a mobility manager of an access network currently identified by the RMF, to determine when the mobile subscriber last accessed via the access network currently identified by the RMF.

Maintaining a record of previous registrations relating to the mobile subscriber may comprise maintaining a record of one or more access networks via which the mobile subscriber has connected.

Maintaining a record of previous registrations relating to the mobile subscriber may comprise maintaining a record of the access network via which the mobile subscriber connected most recently (and, optionally, one or more access networks via which the mobile subscriber previously connected).

Determining whether the mobile subscriber has accessed via a different access network more recently than the request to use the satellite access network may comprise sending a message to a mobility manager of an access network currently identified by the RMF (in respect of the mobile subscriber), to determine when the mobile subscriber last accessed via an access network currently identified by the RMF.

If the mobile subscriber accessed via their home operator network since the request to access via the satellite access network, then the request to access via the satellite access network may be out-of-date. Access via the home operator network may not generate a record in the RMF as the request would not be routed via a roaming hub. Therefore, the RMF may check with the home operator network to determine whether the mobile subscriber has accessed via the home operator network since the request to use the satellite access network.

In other words, the roaming hub may be unable to detect a return of the mobile subscriber to the home network, which could create issues in determining whether the Attach via the satellite access network is current or out-of-date. One solution is to query the home network, as described above. An alternative solution is for the mobility manager in the satellite access network to send extra data, such as the geographic location of the mobile device (estimated by the satellite, to within approximately a 300 km radius, for example) and/or an indication of the last visited location sent by the UE to the mobility manager in the satellite access network (such as the last visited TAI, as an example).

The message sent to the mobility manager of the currently identified access network may be an Insert Subscriber Data message requesting the last UE activity time. The RMF may contact the circuit and/or packet domain (e.g., the circuit domain MSC and/or the packet domain MME/SGSN) in the previous access network (VPLMN). If the UE is not roaming, then the RMF can request the HSS in the HPLMN to retrieve the last activity time from the mobility manager(s) in the HPLMN and return this information to the RMF.

In some alternative examples, the message sent to the mobility manager of the currently identified access network may be an Any Time Interrogation (ATI) message or a Provide Subscriber Information (PSI) message.

Determining whether the mobile subscriber has accessed via a different access network more recently than the request to use the satellite access network may comprise determining whether the mobile subscriber has accessed via a home network.

Determining whether the mobile subscriber has accessed via a home network may comprise sending a query to the home network.

Determining whether the mobile subscriber has accessed via a home network may comprise receiving, from a mobility manager of the satellite access network, a location of a mobile device associated with the mobile subscriber.

The location of the mobile device may comprise a geographic location of the mobile device.

The geographic location of the mobile device may comprise coordinates sent from the mobile device to the mobility manager in the satellite access network.

The geographic location of the mobile device may comprise coordinates estimated by the mobility manager in the satellite access network, based on geographic location of the satellite access node at the time the request was received.

The location of the mobile device may comprise an indication of a last visited location sent from the mobile device to the mobility manager in the satellite access network. For example, the last visited location may be a last visited Tracking Area Identity (TAI) and/or a PLMN ID (comprising a network country and tracking area code).

The location information may be used to determine whether the mobile device is away from the subscriber's home country. If the mobile device is away from the subscriber's home country, then the roaming hub may determine that the mobile subscriber has not accessed via a home network more recently than the request to use the satellite access network.

A network entity configured to perform the method of any preceding claim is also provided.

Computer software comprising instructions that, when executed on a processor, cause the processor to perform the methods described above is also provided.

### BRIEF DESCRIPTION OF THE DRAWINGS

FIG. 1 illustrates an example message flow for a 4G EPC Attach process.

FIG. 2A illustrates a method for initiating a connection between a mobile device and an operator network via a satellite access network.

FIG. 2B illustrates an example method for initiating a connection between a mobile device and an operator network via a satellite access network and a roaming hub.

FIG. 3 illustrates a flowchart of an example method.

FIG. 4 illustrates a flowchart of another example method.

FIG. 5 illustrates a flowchart of another example method.

FIG. 6 illustrates a schematic of an example network entity.

### DETAILED DESCRIPTION

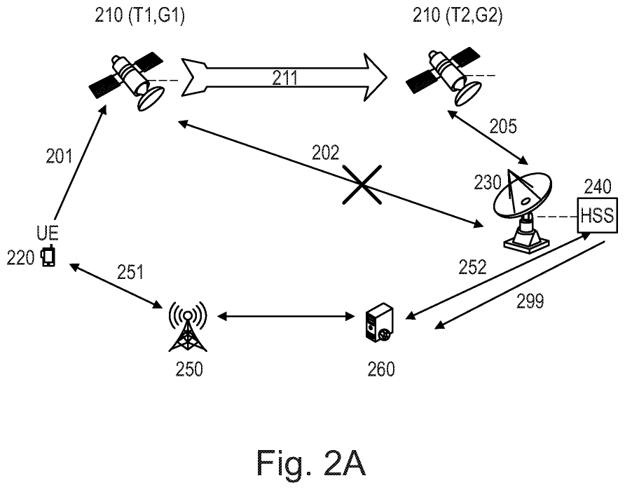

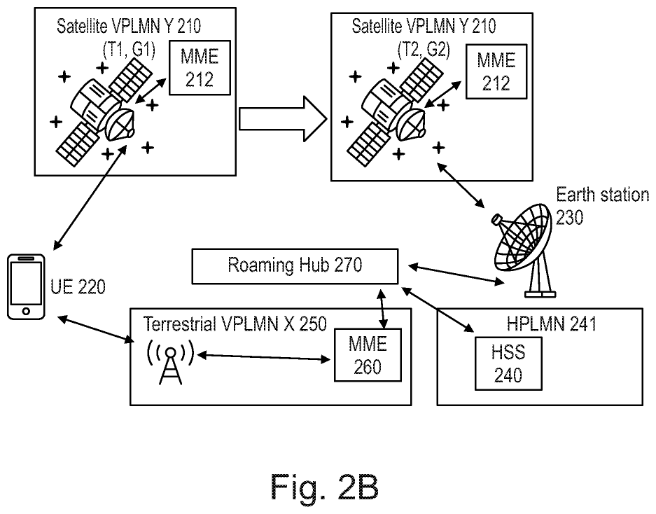

The present invention provides an improved method for communicating via a satellite by using the authentication parameters of a terrestrial HPLMN. These methods are especially relevant to store-and-forward satellite systems, where the connected devices are tolerant to long delays/data latency. Such systems may not have complete satellite constellations or Earth station placement. In an extreme example, it is desirable for the system to function correctly and provide global mobile service with just one satellite and just one Earth station. An example method is illustrated with reference to FIG. 2A.

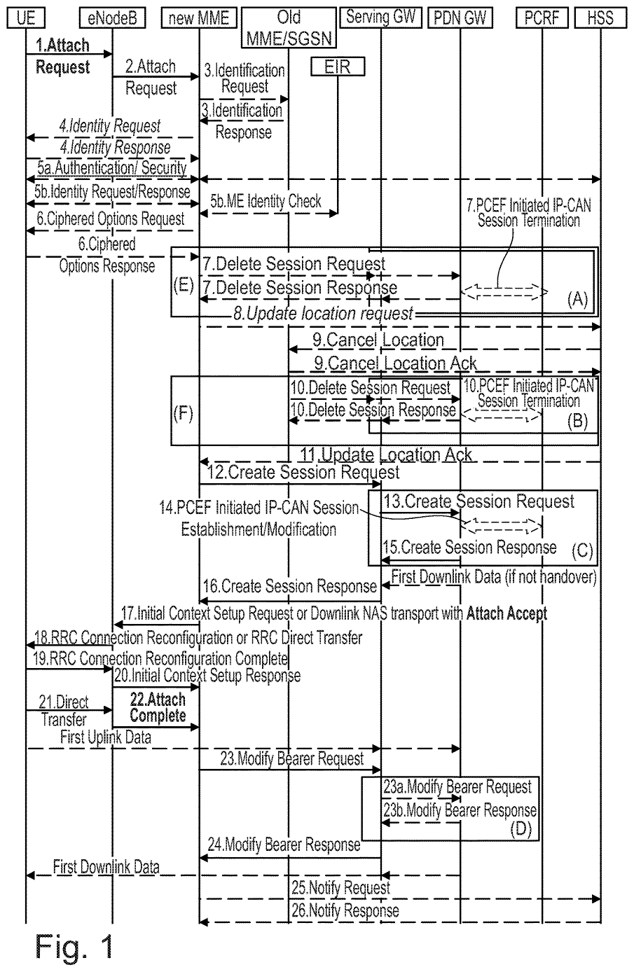

At a first time T1, satellite 210 is located at a Geo-Location G1. The satellite 210 is a PLMN satellite, such that it provides (or appears to provide) a complete network. The satellite therefore comprises a RAN and core network components, including an MME. At this location, the satellite 210 is in range of UE 220. At step 201, the UE determines that the satellite is within range and attempts to Attach via the RAN. This process corresponds to steps, 2 and 4 of FIG. 1.

At T1, G1, the satellite does not have a connection to an Earth station (as illustrated by arrow 202, which is crossed out). Therefore, the MME stores the UE-Identity (IMSI) and waits for a connection to an Earth station to become available. Since the satellite is in orbit, the geographic location of the satellite is constantly changing, as indicated by arrow 211.

At a second time T2, satellite 210 is located at a Geo-Location G2. At this location, an Earth station 230 is in range and the satellite is able to communicate with the HSS 240 of the subscriber's home network via the Earth station 230, as indicated by arrow 205. The MME of the satellite-based network is therefore able to perform step 5a (the MME to HSS part, but not the UE to MME part) and step 8 illustrated in FIG. 1.

In another example, the satellite remains at position G1 but the Earth revolves so that Earth station 230 is in range of the satellite 210. At a second time T2, the satellite is able to communicate with the HSS 240 of the subscriber's home network via the Earth station 230, as indicated by arrow 205. The MME of the satellite-based network is therefore able to perform step 5a (the MME to HSS part, but not the UE to MME part) and step 8 illustrated in FIG. 1.

Even though the UE is out of contact with the satellite, the MME may issue an Update Location Request (ULR) to the HSS including the UE's IMSI and the MME's identity and VPLMN ID. The HSS updates the location register to reflect that the UE is located in this MME. If there was an old MME entry, this triggers the HSS to send the Cancel Location Request (CLR) to notify the old MME about the change.

One issue arises with the proposed process due to the considerable time between messages 201 and 205 in FIG. 2A (corresponding to steps 4 and 5a in FIG. 1). During this time, the UE is in an unregistered state and could select another access network, such as a terrestrial access network PLMN X, illustrated as 250 in FIG. 2A. At step 251, the UE may successfully Attach to PLMN X. At step 252, the CN/MME 260 of terrestrial PLMN X would communicate with the HSS 240 of the HPLMN in the usual way to authenticate and update the location register. (Note that if PLMN X was the last used PLMN before the attempt to access the satellite, then PLMN X might not contact the HSS at step 252.)

Then, when step 205 in FIG. 2A happens some time later, the HSS 240 (which is unaware that the message from the satellite relates to an Attach that was initiated some time ago) behaves as if the UE has just recently Attached to the satellite PLMN (PLMN Y). As a result, the HSS 240 would update the location register to reflect that the UE is connected to PLMN Y and at step 299 would cancel (as in step 9 of FIG. 1) the UE's registration in PLMN X. This would constitute a major security attack on PLMN X, the UE and the HPLMN. Therefore, the HPLMN would tear up (or not sign) a roaming agreement with this satellite system PLMN Y.

### Timestamp

In a first embodiment, the satellite MME includes a timestamp of when the UE 220 sends an Attach Request and IMSI to the MME (step b above) as a new parameter in the signalling (205) to the HSS 240 in FIG. 2A (step 5a and/or step 8 illustrated in FIG. 1). Then, the HSS 240 can determine whether this Request is older or newer than the last access to the UE's currently registered PLMN (which may be VPLMN or HPLMN). Based on this, the HSS can determine how to respond to the satellite operator (e.g., to supply authentication vectors, if the Request is new or reject, if there is a newer access to the currently registered PLMN).

### Roaming Hub

The role of a Roaming Hub is described in GSMA IR.80: Technical Architecture Alternatives for Open Connectivity Roaming Hubbing Model, Version 3.0, which is incorporated by reference.

Since there may be approximately 700 4G networks in the world, many agreements may be required to enable roaming between all of them. To make roaming agreements more efficient, Roaming Hubs may be used to broker agreements between PLMNs. Other services may also be provided by Roaming Hubs. For example, Roaming Hubs may clean up the signalling to ensure compatibility/consistency.

FIG. 2B illustrates an example method for initiating a connection between a mobile device and an HPLMN via a satellite access network and a Roaming Hub.

Messages sent from the MME 212 in the satellite access network 210 to the HSS 240 in the home network 241 may be sent via a Roaming Hub 270. For example, communications in steps 5a (MME to HSS part) and 8 illustrated in FIG. 1 may be sent via the Roaming Hub 270. The Roaming Hub 270 may be configured to determine whether the Attach Request from the UE 220 to the satellite access network 210 is the most recent access to a PLMN by the UE 220. If so, the Roaming Hub 270 may convey the message between the MME 212 and the HSS 240. However, if the Roaming Hub 270 determines that the Attach Request from the UE 220 to the satellite access network 210 is not the most recent access to a PLMN by the UE 220, the Roaming Hub 270 may reject the Request or cause a timeout.

Additional parameters may be included in the message from the MME 212 in the satellite access network 210 to the HSS 240 in the home network 241, including:
The satellite MME 212 could provide a geographic location of the UE 220 into the signalling at steps 5a and/or 8 (or at least a best estimate, based on the location of the satellite at the time of the Attach Request); and/or
The satellite MME 212 could add the “last visited TAI” (sent by the UE 220 (in message 1 of FIG. 1) to the MME 212) into the signalling at steps 5a (from MME to HSS) and/or 8.

This extra information could assist a “signalling function” in a Roaming Hub 270 to determine whether the UE 220 is away from the subscriber's home country and/or PLMN. Based on this determination, the Roaming Hub 270 may determine whether the message from the satellite relates to a Request that is “old” or “new” (i.e., more or less recent than the last access to the previously registered VPLMN for the UE 220) and act accordingly (e.g., by forwarding the message to the HSS 240, if the Request is new, or rejecting the message or causing a timeout, if the Request is old). Advantageously, by providing this updated functionality in the Roaming Hub 270, satellite service may be enabled without requiring upgrades to the HSS 240 in the HPLMN 241.

The TAI may provide an indication of the last visited tracking area. This may be in the form of a PLMN ID (comprising a network country and tracking area code). This indication may be provided to the satellite from the UE. This can be used by the Roaming Hub 270 to assist with the determination of whether the message from the satellite is current or out-of-date.

The Roaming Hub 270 may send an Insert Subscriber Data message to the previously registered VPLMN to determine when the UE last accessed that VPLMN, or, if the UE is not roaming, the Roaming Hub may interrogate the HPLMN's HSS to determine when the UE last accessed the HPLMN.

There may be significantly more HSS entities than Roaming Hubs in the global network. Therefore, implementing the invention in the Roaming Hubs, rather than in every HSS, may require updates to fewer entities in the network and so may be more efficient.

### New Rat Type

In a second embodiment, a new RAT type (or other indication that the Attach Request is being sent via a store-and-forward satellite) could be added to the Authentication Request and/or the Update Location Request in step 5a (MME to HSS) and/or 8 (illustrated in FIG. 1).

In a third embodiment, the HSS may allow the subscriber to be simultaneously registered on both PLMNs X and Y. The new RAT type may be used for PLMN Y.

In the third embodiment, the HSS maintains two location register entries (pointers indicating where the subscriber is accessing). By maintaining two separate entries, the HSS may allow the mobile subscriber to connect via two RAN networks of the same type.

To enable the solution of the third embodiment, security vectors for each of the RAN networks may be provided from different sequences. The HSS may provide the satellite MME with a set of security vectors from a sequence number set that is separate from the sequence numbers provided to terrestrial MMEs, to avoid the UE's SIM detecting a “replay or ‘out of sequence’ security challenge based attack”.

By selecting the security vectors from separate sequences, the HSS ensures that security vectors cannot be replayed. For security, vectors have sequence numbers that increment. Therefore, anything out of sequence is ignored.

The SIM of the mobile device can break up sequences into separate streams. Different sequences may be used for different domains. Therefore, a satellite domain could be maintained separately from a standard 4G domain.

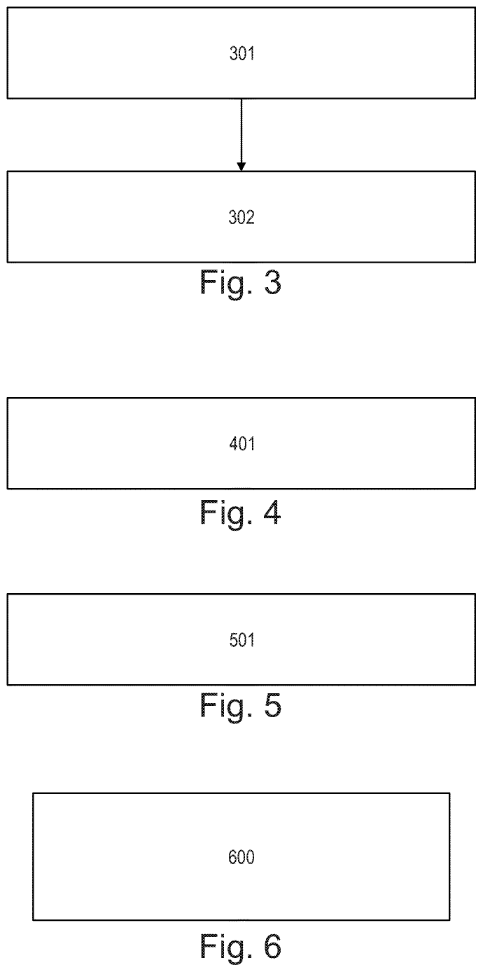

FIG. 3 illustrates a flowchart of an example method of enabling mobile device communication via an access network. The access network is a satellite access network. The method comprises:
at step 301: receiving, at a satellite access node of the satellite access network, a request from a mobile device to use the satellite access network, wherein the request comprises an identifier of a mobile subscriber associated with the mobile device;
at step 302: sending a message to a subscriber database in a home operator network of the mobile subscriber, wherein the message comprises the identifier and one or more of:
   a) a timestamp indicating when the mobile device requested to use the satellite access network; and
   b) information to enable the home operator network to determine that the access network is a satellite access network.

FIG. 4 illustrates a flowchart of an example method of managing a subscriber database in a home operator network. The method comprises:
at step 401: receiving, at the subscriber database, a message from an access network, wherein the access network is a satellite access network, wherein the message comprises an identifier of a mobile subscriber that has requested to use the satellite access network, wherein the message further comprises one or more of:
   a) a timestamp indicating when the mobile subscriber requested to use the satellite access network; and
   b) information enabling the home operator network to determine that the access network is a satellite access network.

FIG. 5 illustrates a flowchart of an example method of communicating between a satellite access network and a home operator network. The method comprises:
at step 501: receiving, at a Roaming Hub, a message from a satellite access network, wherein the message comprises:
   an identifier of a mobile subscriber that has requested to use the satellite access network, and
   a timestamp indicating when the mobile subscriber requested to use the satellite access network.

FIG. 6 illustrates a schematic of an example network entity 600. The network entity 600 is configured to perform any of the example methods described in this application.

Any of the methods described herein may be implemented as a computer programme. The computer programme may be configured to control a RAT entity (e.g., a network node) and/or UE to perform any method according to the disclosure. A RAT entity (e.g., a network node) of a cellular network and/or a UE may also be provided, configured to operate in accordance with certain methods disclosed herein. For example, the RAT entity may include a processor and at least one communication interface, particularly comprising one or both of a transmitter and receiver. A UE may also be provided, configured to operate in accordance with certain methods disclosed herein. The UE may likewise include a processor and at least one communication interface, particularly comprising one or both of a transmitter and receiver.

Although specific embodiments have now been described, the skilled person will understand that various modifications and variations are possible. For example, whilst the disclosure is described in relation to existing network architecture, it will be understood that changes to the architecture (and/or nomenclature) are possible, but the present disclosure may still be applicable in this case. Also, combinations of any specific features shown with reference to one embodiment or with reference to multiple embodiments are also provided, even if that combination has not been explicitly detailed herein.

A base station may be referred to as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology, depending on the protocol, standard, context or technology. In some examples, a base station may include two or more transceivers that may or may not be collocated. Each transceiver may communicate on the same or different carrier frequency within the same or different frequency band.

Where this application refers to a server or network entity, for instance, this may actually be a pair of servers, or network entities (primary and failover), for redundancy.

Whilst the above methods are described in relation to a 4G network, these methods, techniques, apparatuses, and systems may be applied to a variety of wireless multiple access systems. Examples of the multiple access systems include 5G Core with 5G-NR; a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP E-UTRAN/EPC system, aspects of the present invention that are not specific to 3GPP E-UTRAN/EPC are applicable to other mobile communication systems.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a gNB, a base transceiver system (BTS), an access point (AP), a processing server (PS), etc. In describing the present invention, a BS will be referred to as an gNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a g-node B (gNB), a relay, a repeater, etc. may be a node.

In the present invention, a cell refers to a geographical area to which one or more nodes provide a communication service. Accordingly, in the present invention, communicating with a specific cell may mean communicating with an eNB or a node which provides a communication service to the specific cell. Furthermore, channel status/quality of a specific cell refers to channel status/quality of a channel or communication link formed between an eNB or node which provides a communication service to the specific cell and a UE. The UE may measure DL channel state received from a specific node using cell-specific reference signal(s) (CRS(s)) transmitted on a CRS resource and/or channel state information reference signal(s) (CSI-RS(s)) transmitted on a CSI-RS resource, allocated by antenna port(s) of the specific node to the specific node. Meanwhile, a 3GPP system uses the concept of a cell in order to manage radio resources and a cell associated with the radio resources is distinguished from a cell of a geographic region.

The examples may be carried out on any suitable data processing device, such as a personal computer, laptop, mobile telephone, server, virtual machine, and the like. The above description of the systems and methods has been simplified for purposes of discussion, and is intended to provide a specific example to illustrate the invention. Different types of systems and methods may be used, as will be appreciated by the skilled person. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

Examples may be implemented by computer software or a “computer program”. A storage medium and a transmission medium carrying the computer software are also provided. The computer software may comprise one or more instructions, or code, that, when executed by a computer, causes the methods described to be performed. Computer software may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and vice versa. For instance, unless the context indicates otherwise, a singular reference herein including in the claims, such as “a” or “an” (such as a UE, a node, a network entity, a RAN entity, or a cell) means “one or more” (for instance one or more UE, one or more nodes, one or more network entities, one or more RAN entities, or one or more cells). Throughout the description and claims of this disclosure, the words “comprise”, “including”, “having” and “contain” and variations of the words, for example “comprising” and “comprises” or similar, mean “including”, and are not intended to (and do not) exclude other components.

The use of any and all examples, or exemplary language (“for instance”, “such as”, “for example” and like language) provided herein, is intended merely to better illustrate the invention and does not indicate a limitation on the scope of the invention unless otherwise claimed. No language in the specification should be construed as indicating any non-claimed element as essential to the practice of the invention.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. As described herein, there may be particular combinations of aspects that are of further benefit, such the aspects of determining a set of compensation parameters and applying a set of compensation parameters to measurements. In particular, the preferred features of the invention are applicable to all aspects of the invention and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

1. A method of enabling mobile device communication via an access network, wherein the access network is a satellite access network, the method comprising:
receiving, at a satellite access node of the satellite access network, a request from a mobile device to use the satellite access network, wherein the request comprises an identifier of a mobile subscriber associated with the mobile device;
sending a message to a subscriber database in a home operator network of the mobile subscriber, wherein the message comprises the identifier and
a timestamp indicating when the mobile device requested to use the satellite access network.
wherein the timestamp is suitable for determining whether the mobile subscriber has accessed via a different access network more recently than the request to use the satellite access network.

2. The method of claim 1, further comprising:
storing a record of the request from the mobile device, wherein the record comprises the identifier.

3. The method of claim 2, wherein storing a record of the request from the mobile device comprises storing the record at a mobility manager of the satellite access network.

4. The method of claim 1, wherein the message sent to the subscriber database comprises a request to update a location register of the subscriber database.

5. The method of claim 4, further comprising:
sending, to the subscriber database, a request for authentication data.

6. The method of claim 1, wherein the message sent to the subscriber database comprises a request for authentication data.

7. The method of claim 6, further comprising:
sending, to the subscriber database, a request to update a location register of the subscriber database.

8. The method of claim 1, further comprising:
determining that a connection between the satellite access node and the home operator network is not available; and
at a later time, determining that a connection between the satellite access node and the home operator network is available, wherein the request for authentication data is sent to the subscriber database in response to the determination that the connection between the satellite access node and the home operator network is available.

9. The method of claim 8, wherein determining that a connection between the satellite access node and the home operator network is not available comprises requesting the authentication data and determining that a time-limit for receiving a response to the request has been exceeded.

10. The method of claim 8, wherein determining that a connection between the satellite access node and the home operator network is available comprises determining that an Earth station of the satellite access network has come into range of the satellite access node.

11. The method of claim 1, wherein sending the message to the subscriber database comprises sending the message to the subscriber database via a roaming hub.

12. A method of managing a subscriber database in a home operator network, the method comprising:
receiving, at the subscriber database, a message from an access network, wherein the access network is a satellite access network, wherein the message comprises an identifier of a mobile subscriber that has provided a request to use the satellite access network, wherein the message further comprises
a timestamp indicating when the mobile subscriber requested to use the satellite access network,
wherein the method further comprises determining, based on the timestamp, whether the mobile subscriber has accessed via a different access network more recently than the request to use the satellite access network.

13. The method of claim 12, wherein the message comprises a request for authentication data.

14. The method of claim 13, wherein the method comprises receiving a request to update a location register of the subscriber database.

15. The method of claim 12, wherein the message comprises a request to update a location register of the subscriber database.

16. The method of claim 15, wherein the method further comprises receiving a request for authentication data.

17. (canceled)

18. The method of claim 12, wherein, if the mobile subscriber has accessed via a different access network more recently than the request to use the satellite access network, the method further comprises either:
responding to the message from the satellite access network with an error; or
disregarding the message from the satellite access network.

19. The method of claim 12, wherein, if the mobile subscriber has not accessed via a different access network more recently than the request to use the satellite access network, the method further comprises responding to the message by one or more of:
sending authentication data to the satellite access network; and
updating a location register of the subscriber database.

20. The method of claim 12, wherein determining whether the mobile subscriber has accessed via a different access network more recently than the request to use the satellite access network comprises:
sending a message to a mobility manager of an access network currently identified in a location register of the subscriber database, to determine when the mobile subscriber last accessed via an access network currently identified in the location register of the subscriber database.

21.-26. (canceled)

27. A network entity configured to perform the method of claim 1.

28. A computer program product comprising a non-transitory computer readable storage medium comprising instructions that, when executed on a processor, cause the processor to perform the method of claim 1.

29. The method of claim 1, wherein the message further comprises information to enable the home operator network to determine that the access network is a satellite access network.

30. The method of claim 12, wherein the message further comprises information to enable the home operator network to determine that the access network is a satellite access network.

31. The method of claim 30, wherein the subscriber database is configured to maintain:
a first location register entry in respect of connections made from the mobile subscriber via satellite access networks including the satellite access network, and
a second location register entry in respect of connections made from the mobile subscriber via other access networks, and
wherein the method further comprises updating the first location register entry.
